(19) United States
(12) Patent Application Publication
(10) Pub. No.: US 2015/0076872 A1
(43) Pub. Date: Mar. 19, 2015

(54) Catching Device for Use with Seats

(71) Applicants: James Colby Carithers, Anderson, SC (US); Andrew Thomas Brannon Cooper, Anderson, SC (US)

(72) Inventors: James Colby Carithers, Anderson, SC (US); Andrew Thomas Brannon Cooper, Anderson, SC (US)

(21) Appl. No.: 14/490,309

(22) Filed: Sep. 18, 2014

Related U.S. Application Data
(60) Provisional application No. 61/879,480, filed on Sep. 18, 2013.

(51) Int. Cl. B60N 2/44; A47C 31/00; B60R 11/00

(52) U.S. Cl. CPC B60N 2/44; B60R 11/00; A47C 31/00; B60R 2011/0007; B60R 2011/0012
USPC 297/182

(57) ABSTRACT

Disclosed is a liner for catching items that fall between seat cushions of a furniture or between a front seat of a vehicle and a center console thereof. The device includes rectangular liner having an open upper end, a closed lower end, a first end, and a second end, defining an interior volume. In one embodiment, the liner is adapted to fold into thirds so as to form a middle panel and two side panels adjacent thereto. The device is adapted to removably attach between the seat cushions or between the front seat of a vehicle and a center console by means of a hook and loop fastener disposed at the upper end of the liner. In this way, the present invention can be used to collect loose items that fall out of a user's pocket when sitting on the furniture or the front seat of a vehicle.

### CROSS REFERENCE TO RELATED APPLICATION

This application claims the benefit of U.S. Provisional Application No. 61/879,480 filed on Sep. 18, 2013. The above identified patent application is herein incorporated by reference in its entirety to provide continuity of disclosure.

### BACKGROUND OF THE INVENTION

1. Field of the Invention

The present invention relates to a catching device for collecting items that fall out of a user's pocket when sitting. More specifically, the present invention pertains to an improved catching device that is adapted to be placed between seat cushions of a furniture or between a front seat and a center console of a vehicle. The catching device is adapted to catch items that would otherwise fall into the gaps between the seat cushions or between the seat and the center console.

Many individuals place small items in the pockets of their apparel. While some pockets include a closure mechanism to prevent items from falling out of the pockets, most pockets are left open such that there is a high likelihood that items such as coins, keys, phones, or other personal belongings may drop from the individual's pocket and fall into the gap between the seat cushions of a furniture when sitting down. To retrieve the items that fall into the gap, individuals must remove the seat cushions and look for the lost item, which may have fallen deeper into the seams or crevices of the furniture. In this way, items may become easily lost or misplaced between the seat cushions of a furniture.

Similarly, many individuals drop small items into the gap between the front seat and the center console of a vehicle when entering and exiting the vehicle. It is incredibly difficult to reach between the front seat and the center console because the gap is often too narrow and the seat adjustment mechanism prevents individuals from easily accessing the gap. Furthermore, as the individuals move the seat to widen the gap or otherwise make the gap more accessible, the seat adjustment mechanism can damage the fallen item. Therefore, there exists a need for a device that can prevent or catch small items that fall into the gap between the seat cushions or the front seats.

The present invention provides a catching device comprising a liner having a defined interior volume formed by a closed lower end, closed side ends, and an open upper end. In one embodiment, the liner is constructed to be placed between the seat cushions of a sofa, couch, loveseat, or the like. In another embodiment, the liner is constructed to be placed between the front seat and the front console of a vehicle. The device is removably attached to a desired location by means of hook and loop fasteners at the upper end thereof. In this way, the device may be removed from a mounted surface when retrieving fallen items therefrom. Subsequently, the device may be reinstalled without inconveniencing the user.

2. Description of the Prior Art

Devices have been disclosed in the prior art that claim liners for catching items that fall between seat cushions. These include devices that have been patented and published in patent application publications. Some of these devices disclose a slip cover with separate covers for the seat cushions. Other devices disclose a remote control caddy that attaches to a chair. These devices, however, do not disclose a liner that attaches to the furniture between the seat cushions, and that attaches between a front seat of a vehicle and a center console thereof. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 6,827,398 to Nazginov discloses a one-piece slip cover comprising a first pouch and a second pouch, wherein the first pouch defines a seat cushion covering and the second pouch defines a furniture base covering. Each of the pouches comprises a perimeter having elastic or other means to cinch the perimeter. The intent and design of the Nazginov device, however, differ from the present invention in that the Nazginov discloses a slip cover with separate pockets for seat cushions for a fitted appearance. In contrast, the present invention provides a liner for catching items that fall between seat cushions. Thus, Nazginov does not disclose a device that enables a user to easily retrieve items that fall between seat cushions.

U.S. Pat. No. 5,692,608 to Simien discloses a remote control caddy comprising a planar sheet of material with a plurality of pockets thereon. The device is adapted to removably attach to a sofa or a chair via a set of pins so that the pockets rest flush against the exterior of the sofa or the chair and the user can readily access the pockets. Similarly, U.S. Pat. No. 5,872,702 to Kopel and U.S. Design Pat. No. D333,580 to Brummett disclose remote control holders comprising a substantially planar sheet of material with one side that is curved. The curved portion allows the device to hang on an arm of a chair, or elevate the device when placed on a horizontal surface. The device further comprises a plurality of pockets for holding one or more remote controls therein.

The foregoing Simien, Kopel, and Brummett devices are directed toward remote control holders. Thus, the foregoing devices are placed on the external portion of a sofa or a chair, and are inoperable to catch items that fall between the seat cushions. In contrast, the present invention provides a liner that is adapted to be placed between the seat cushions of a sofa or a chair. As such, the user must reach between the seat cushion to access the liner. In another embodiment, the present invention provides a liner that is adapted to be placed between a front seat of a vehicle and a center console thereof. The foregoing devices do not disclose a liner that may be used with a seat of a vehicle.

U.S. Pat. No. 4,131,313 to Jacobs discloses a removable storage compartment for vehicle seats. The removable storage compartment comprises a plurality of pockets adapted to be positioned on the front portion of the vehicle seats, and a pair of side pockets adapted to be positioned on the side portions of the vehicle seats. The pockets are attached to an elastic strap having two terminal ends. The strap is wrapped around the vehicle seats and are tied together to secure the pockets in place. In contrast, the present invention comprises a liner that is adapted to be placed between a front seat of a vehicle and a center console. The liner is secured in place via a fastener such as hook and loop fasteners. As such, the liner of the present invention does not wrap around the seat.

Finally, U.S. Pat. No. 5,383,727 to Rife discloses a pouch that may be adapted to a variety of a mounting surface. The pouch comprises an open upper end having a fastener attached thereto. In one embodiment, the fastener comprises a hook and loop fastener. The open upper end of the pouch may be elastic so that the opening may be expanded or substantially closed. Unlike the present invention, the device of Rife comprises a fastener along only one side of the upper end. The present invention comprises a liner having an open end, wherein the open end comprises a perimeter. The fastener of the present invention is disposed along the perimeter. In this way, the present liner remains substantially open when mounted to a surface, thereby catching any items that fall within its interior.

The devices disclosed in the prior art have several known drawbacks. These devices are limited in that they are not designed to be placed between seat cushions or between a front seat of a vehicle and a center console. Additionally, the prior art fails to disclose a liner with a wide opening to catch items therein. The present invention overcomes these limitations by disclosing a liner that can be placed between seat cushions or between a front seat of a vehicle and a center console, depending upon embodiment. In this way, the present invention is able to catch items that fall between the seats and are otherwise difficult to retrieve.

It is therefore submitted that the present invention is substantially divergent in design elements from the prior art, and consequently it is clear that there is a need in the art for an improvement to liners for catching items. In this regard, the instant invention substantially fulfills these needs.

### SUMMARY OF THE INVENTION

In view of the foregoing disadvantages inherent in the known types of liners for catching items now present in the prior art, the present invention provides a new and improved catching device wherein the same can be utilized for catching items that fall between seat cushions and preventing items from falling under seats.

It is therefore an object of the invention to provide a new and improved catching device that has all of the advantages of the prior art and none of the disadvantages.

Another object of the present invention is to provide a new and improved catching device that is adapted to be placed between seat cushions of a sofa, couch, a loveseat, or the like.

Yet another object of the present invention is to provide a new and improved catching device that is adapted to be placed between a front seat of a vehicle and a center console.

Still yet another object of the present invention is to provide a new and improved catching device that is removably secured in place via hook and loop fasteners.

Still yet another object of the present invention is to provide a new and improved catching device that is economic in its construction and durable and efficient as an article of commercial use.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of the first embodiment of the present invention.

FIG. 2 shows a view of the first embodiment of the present invention being inserted into a chair.

FIG. 3 shows a perspective view of the second embodiment of the present invention.

FIG. 4 shows a view of the second embodiment of the present invention being inserted between the front seats of a vehicle and the center console.

### DETAILED DESCRIPTION OF THE INVENTION

References are made herein to the attached drawings. Like reference numerals are used throughout the drawings to depict like or similar elements of the catching device. For the purposes of presenting a brief and clear description of the present invention, the preferred embodiment will be discussed as used for catching items that fall between seat cushions and preventing items from falling under seats. The figures are intended for representative purposes only and should not be considered to be limiting in any respect.

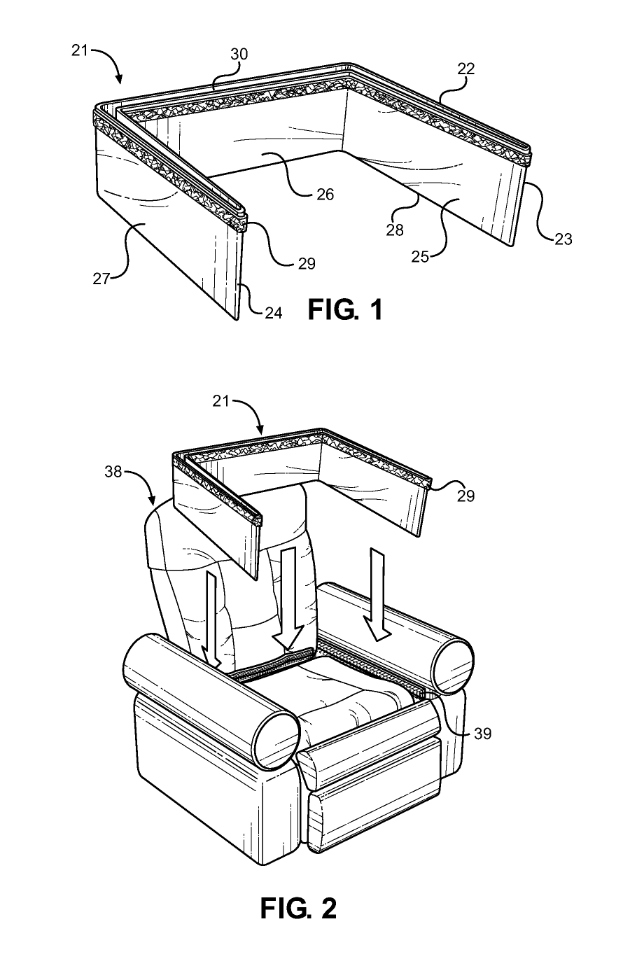

Referring now to FIGS. 1 and 2, there are shown views of the first embodiment of the present invention. The present invention comprises an elongated liner 21 having an open upper end 22, a closed lower end 28, a first end 23, and a second end 24, defining an interior volume 30. The distance between the upper end 22 and the lower end 28 define a height, wherein the height is constant over the length of the upper 22 and lower ends 28.

The liner 21 is an elongated rectangle that may be folded into thirds, forming a first side panel 25, a second side panel 27, and a middle panel 26 therebetween. Each of the first side panel 25, the second side panel 27, and the middle panel 26 is substantially equal in size and shape. In this way, the liner 21 forms a U-shape when viewed from the top, and the liner 21 is symmetrical in structure. It is contemplated that the liner 21 is composed of flexible material such as nylon, leather, or other suitable materials. In some embodiments, the interior volume 30 may comprise a layer of lining fabric that is composed of cotton blend, polyester, silk, or other suitable fabric. The lining fabric may be stitched to the interior of the liner 21 so that it is coextensive therewith and substantially similar in size and dimension. Preferably, the lining fabric has a lower friction than the liner 21 so that the items that fall within the interior volume 30 can easily slide in and out of the interior volume 30.

The upper end 22 of the liner 21 comprises a perimeter having a hook and loop fastener 29 therearound. Preferably, the hook and loop fastener 29 extends around the entire perimeter of the upper end 22. The hook and loop fastener 29 is disposed along the outer surface of the liner 21 so that it does not extend into the interior volume 30 thereof. In this way, the upper end 22 stays open. The hook and loop fastener 29 may be attached to the upper end 22 via strong adhesives, or the hook and loop fastener 29 may be stitched onto the upper end 22.

The liner 21 is constructed to fit between the seat cushions of a couch, a sofa, a chair, or other similar furniture. In FIG. 2, the liner 21 is used with a chair 38. The chair 38 comprises a back portion, a pair of arms, and a seat cushion therebetween. The chair 38 further comprises a gap between the seat cushion and the pair of arms, as well as a gap between the seat cushion and the back portion. In use, strips of hook and loop fasteners 39 are placed near the gap between the seat cushion and the pair of arms, and near the gap between the seat cushion and the back portion. Preferably, a separate strip of hook and loop fasteners 39 is used for each of the arms and the back portion. Additionally, strips of hook and loop fasteners 39 may be placed on the sides and the back of the seat cushion. The hook and loop fasteners 39 may comprise adhesive backing so that it can be secured to the chair. Alternatively, the hook and loop fasteners 39 may be stitched to the chair 38. The hook and loop fasteners 39 directly align with the hook and loop fasteners 29 so that the liner 21 can be removably attached within the gaps of the chair 38.

When secured in place, the upper end 22 of the liner 21 is substantially level with the top surface of the seat cushion and the lower end 28 extends below the seat cushion. Additionally, the middle panel is positioned between the seat cushion and the back portion, while the first and second side panels are positioned between the seat cushion and the pair of arms. The liner 21 does not interfere with the functionality of the chair 38. The upper end 22 of the liner 21 stays open, thereby catching any items in the interior volume 30 that would otherwise fall into the gap between the seat cushion and the pair of arms, or into the gap between the seat cushion and the back portion. In this way, the present invention provides convenience to the user by catching items that fall out of the user's pocket when sitting on the chair 38, preventing items from getting lost or damaged.

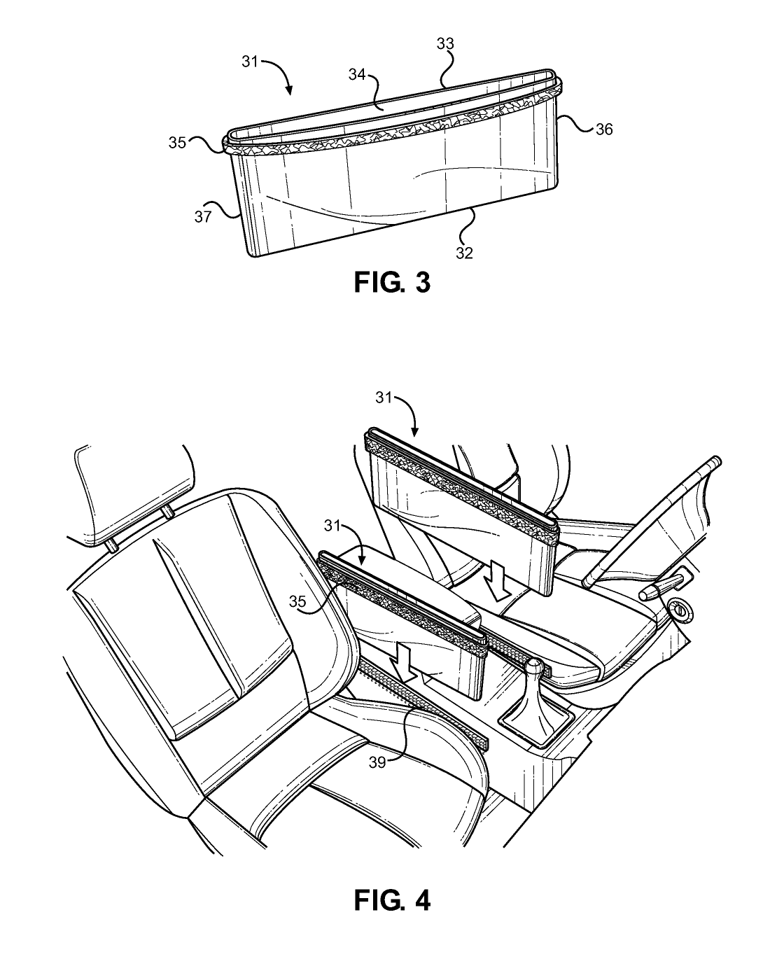

Referring now to FIGS. 3 and 4, there are shown views of the second embodiment of the present invention. The illustrated embodiment of the liner 31 comprises an open upper end 33, a closed lower end 32, a first end 36, and a second end 37, defining an interior volume 34. The distance between the upper end 33 and the lower end 32 define a height. The liner 31 is substantially rectangular in shape. As such, the height of the liner 31 is constant over the length of the upper end 33 and the lower end 32, and the first end 36 is substantially parallel to the second end 37. Similar to the first embodiment, the liner 31 is composed of flexible material such as nylon, leather, or other suitable materials. In some embodiments, the interior volume 34 may comprise a layer of lining fabric that is composed of cotton blend, polyester, silk, or other suitable fabric. The lining fabric may be stitched to the liner 31 so that it is coextensive therewith and substantially similar in size and dimension. Preferably, the lining fabric has a lower friction than the liner 31 so that the items that fall within the interior volume 34 can easily slide in and out of the interior volume 34.

The upper end 33 of the liner 31 comprises a perimeter having a hook and loop fastener 35. The hook and loop fastener 35 extends around the entire perimeter of the upper end 33. The hook and loop fastener 35 is disposed along the outer surface of the liner 31 so that it does not extend into the interior volume 34 thereof. In this way, the upper end 33 stays open. The hook and loop fastener 35 may be attached to the upper end 33 via strong adhesives, or the hook and loop fastener 35 may be stitched onto the upper end 33.

The liner 31 is constructed to fit between a front seat of a vehicle and a center console. In use, strips of hook and loop fasteners 39 are placed on opposing sides of the center console so that the hook and loop fasteners 39 are substantially level with the top of the front seats. It is contemplated that the hook and loop fasteners 39 may comprise adhesive backing thereon so that it can be secured in place during use. Optionally, additional strips of hook and loop fasteners 39 may be placed on the side of the seat facing the center console. The hook and loop fasteners 39 directly align with the hook and loop fasteners 35 so that the liner 31 is removably attached to the front seat and the center console.

When secured in place, the upper end 33 of the liner 31 is substantially level with the top surface of the front seat and the lower end 32 extends below the gap between the seat and the center console. The upper end 33 of the liner 31 stays open, thereby catching any items in the interior volume 30 that would otherwise fall into the gap between the front seat and the center console. In this way, the present invention provides convenience to the user by catching items that fall out of the user's pocket when sitting on the front seat, preventing items from getting lost or damaged.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A catching device for use with seats, comprising:
a rectangular liner having an open upper end, a closed lower end, a first end opposite a second end, an interior volume, and a perimeter along an exterior surface of said upper end;
a hook and loop fastener that extends around said perimeter;
said liner adapted to fold into thirds, forming a first side panel, a middle panel, and a second side panel;
wherein each of said first side panel, said middle panel, and said second side panel is substantially equal in size and dimension;
wherein said first side panel is symmetrical to said second side panel;
at least one strip of hook and loop fastener adapted to be placed on a pair of arms of a chair and a back portion of said chair;
wherein said at least one strip of hook and loop fastener is directly aligned with said hook and loop fastener of said liner.

2. The catching device of claim 1, further comprising a lining fabric in said interior volume of said liner.

3. A catching device for use with seats, comprising:
a rectangular liner with an open upper end, a closed lower end, a first end opposite a second end, an interior volume, and a perimeter along an exterior surface of said upper end;
a hook and loop fastener that extends around said perimeter;
at least one strip of hook and loop fastener adapted to be placed on a side of a center console of a vehicle;
wherein said at least one strip of hook and loop fastener is directly aligned with said hook and loop fastener of said liner.

4. The catching device of claim 3, further comprising a lining fabric in said interior volume of said liner.
